(19) United States
(12) Patent Application Publication
(10) Pub. No.: US 2017/0135906 A1
(43) Pub. Date: May 18, 2017

(54) A TIME-ORIENTED PILL DISPENSER

(71) Applicants: Reuben BERMAN, Beer Sheva (IL); Anna Berman, Beer Sheva (IL)

(72) Inventors: Reuben BERMAN, Beer Sheva (IL); Anna Berman, Beer Sheva (IL)

(21) Appl. No.: 15/322,121

(22) PCT Filed: Jun. 26, 2014
(86) PCT No.: PCT/IL2014/050578

§ 371 Date: Dec. 26, 2016

(51) Int. Cl. A61J 7/04; B65D 43/02; B65D 51/24; A61J 7/00

(52) U.S. Cl. CPC A61J 7/04; A61J 7/0076; B65D 43/0214; B65D 51/245; A61J 2200/30; A61J 2205/50; A61J 2205/40; A61J 2205/20

(57) ABSTRACT

In one aspect, the present invention is directed to a time-oriented pill dispenser, comprising: a bulk pills container having an opening, and a corresponding lid; an impression of different time notations, dispersed on an external side of a wall of the container along a circumference thereof, in proximity to the lid; and a pointer in a form of a tab of the lid, or a mark on the lid, for pointing at one of the time notations of the impression in a closed state of the container; wherein securing the lid to the container enables placing the pointer to point at each of the notations; thereby on closing the container by the lid, enabling a user marking the current time as the last time of taking a pill from the container by positioning the pointer on the corresponding time notation in the impression.

### TECHNICAL FIELD

The present invention relates to the field of pill dispensers. More particularly, the invention relates to a time-oriented pill dispenser.

### BACKGROUND ART

One of the problems a user faces when prescribed medication over a lengthy period of time is an absence of indication about the last time a pill of a certain kind (such as, for example, Aspirin and Zinat) has been taken. For example, assuming a user must take an antibiotic three times a day, for a period of 10 days, one at morning, one at noon, and one at evening, at some point he might find it difficult to remember how many pills he has taken each day, and for how many days.

US Patent publications 3,651,927, 3,450,306, 6,510,962, 5,575,392, 4,534,468, 20030192468, 2,739,564, as well as EP 0807589, are considered as the closest prior art. Each of these publications and many others which have not been mentioned above presents a time-oriented pill dispenser, which solves this problem. However, these dispensers consist of a dedicated mechanism, which is cumbersome, separate from the bulk pills container in which the pills are distributed, requires special design and engineering, and so on.

The huge number of solutions indicates that there is a long felt need for a simple solution to a time-oriented pill dispenser.

It is an object of the present invention to provide a solution to the above-mentioned and other problems of the prior art.

Other objects and advantages of the invention will become apparent as the description proceeds.

### SUMMARY OF THE INVENTION

The present invention is directed to a time-oriented pill dispenser.

In one aspect, the present invention is directed to a time-oriented pill dispenser, comprising:
a bulk pills container (12) having an opening (14), and a corresponding lid (16);
an impression (20) of different time notations, dispersed on an external side of a wall of the container (12) along a circumference thereof, in proximity to the lid (16); and
a pointer in a form of a tab (18) of the lid (16), or a mark (22) on the lid (16), for pointing at one of the time notations of the impression (20) in a closed state of the container (12);
wherein securing the lid (16) to the container (12) enables placing the pointer to point at each of the notations;
thereby on closing the container (12) by the lid (16), enabling a user marking the current time as the last time of taking a pill from the container by positioning the pointer on the corresponding time notation in the impression.

In another aspect, the present invention is directed to a time-oriented pill dispenser, comprising:
a bulk pills container (12) having a symmetric circular or polygonal opening (14), and a corresponding lid (16);
a plurality of impressions (20, 20′) of different time notations (10:00, 12:00, etc.), dispersed on an external side of the lid (16) or the container (12) along a circumference thereof; and
a pointer on the lid (16) or on the container (12), disposed in proximity to the time notations of the impression (20);
wherein securing the lid (16) to the container (12) enables placing the pointer to point at each of the notations;
thereby on closing the container (12) by the lid (16), marking the current time as the last time of taking a pill from the container by positioning the pointer on the corresponding time period in the impression,
wherein the plurality of impressions (20, 20′) being adapted to enable selecting one of the plurality of impressions.

In yet another aspect, the present invention is directed to a time-oriented pill dispenser, comprising:
a bulk pills container (12) having a symmetric circular or polygonal opening (14), and a corresponding lid (16);
one or more impressions (20, 20′) each of different time notations (10:00, 12:00, etc.), dispersed on an external side of the lid (16) or the container (12) along a circumference thereof; and
a pointer on the lid (16) or on the container (12), disposed in proximity to the time notations of the impression (20);
wherein securing the lid (16) to the container (12) enables placing the pointer to point at each of the notations;
thereby on closing the container (12) by the lid (16), marking the current time as the last time of taking a pill from the container by positioning the pointer on the corresponding time period in the impression;
wherein each of the impressions is on a sticker;
thereby (a) reducing a manufacturing effort of the pill dispenser, and (b) enabling using of multiple time impressions from which a user may select one.

The time notations may be of days of a week, of days of a month (1, 2, 3, . . . , 31), of hours of a day (01:00, 02:00, . . . , 24:00), of descriptive times of a day (morning, noon, afternoon, evening, night), and so on.

According to one embodiment of the invention, the inner side (26) of the lid (16) is ribbed, and an outer side of a mouth (24) of the opening (14) is ribbed, thereby generating a friction which prevents unintentional displacement of the lid with reference to the container.

According to another embodiment of the invention, the inner side (26) of the lid (16) is non-smooth and an outer side of a mouth (24) of the opening (14) is non-smooth, thereby generating a friction for preventing unintentional displacement of the lid with reference to the container.

The impression (20) may be in the form of a print, in the form of an engraving, and so on.

According to one embodiment of the invention, the friction and structure between the lid (16) and the opening (14) is designed to prevent unintentional change of a position of the lid with reference to the container.

The sticker may be removable, thereby allowing a user to remove undesired impression(s) from the container for preventing erring of use.

According to one embodiment of the invention, the sticker is attachable, thereby allowing a user to attach a desired impression to the container for preventing erring of use.

The pills may be of the same kind, or of different kinds, each kind in a different color, corresponding to the background color of the respective time notation.

According to one embodiment of the invention, the lid is elastic, thereby providing a friction between the lid and the opening of the container, for preventing unintentional displacement of the lid with reference to the container.

The time notations may be textual, colored, in the form of a background color of text, and so on.

According to one embodiment of the invention, the connection is carried out without a thread.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Preferred embodiments, features, aspects and advantages of the present invention are described herein in conjunction with the following drawings:

FIG. 1 schematically illustrates a time-oriented pill dispenser in its open state, according to one embodiment of the invention.

FIG. 2 schematically illustrates the dispenser of FIG. 1, in its closed state.

FIG. 3 schematically illustrates a time-oriented pill dispenser, according to another embodiment of the invention.

FIG. 4 schematically illustrates a time-oriented pill dispenser, according to yet another embodiment of the invention.

FIG. 5 schematically illustrates a time-oriented pill dispenser, according to yet another embodiment of the invention.

FIG. 6 schematically illustrates a time-oriented pill dispenser, according to yet another embodiment of the invention.

FIG. 7 schematically illustrates a time-oriented pill dispenser, according to yet another embodiment of the invention.

FIG. 8 schematically illustrates a time-oriented pill dispenser, according to yet another embodiment of the invention.

FIG. 9 schematically illustrates a time-oriented pill dispenser, according to yet another embodiment of the invention.

FIG. 10 schematically illustrates a time-oriented pill dispenser, according to yet another embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

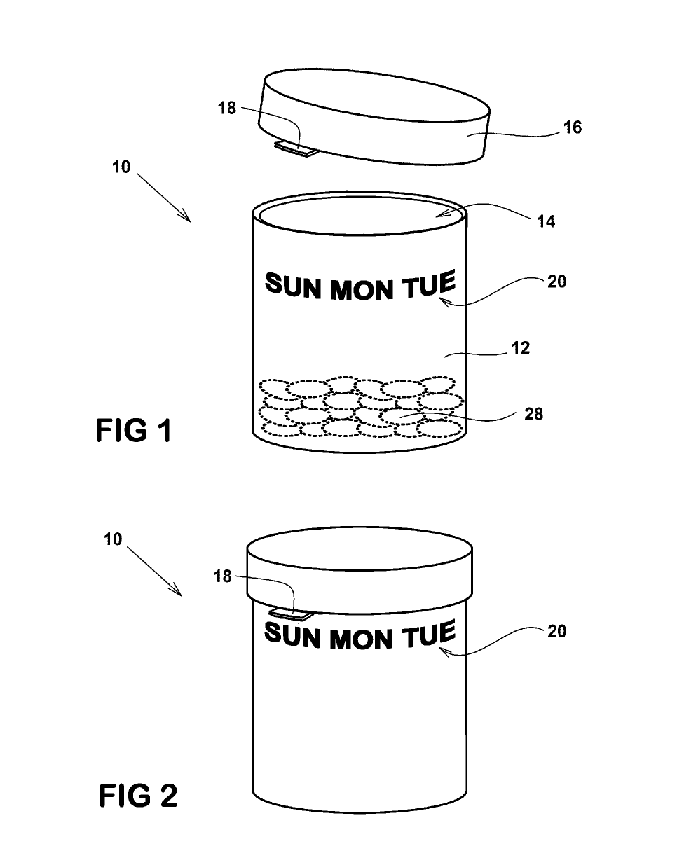

FIG. 1 schematically illustrates a time-oriented pill dispenser in its open state, according to one embodiment of the invention.

The dispenser, which is marked herein by reference numeral 10, comprises a bulk pills container 12, in which the opening 14 thereof is circular, and the corresponding lid 16 thereof is also circular. In the figure, the dispenser is in its open state. The pills are marked herein by reference numeral 28, and are presented in this figure in a dotted line, as they reside inside the container, thereby being hidden by the walls of the container.

The opening mechanism comprises a tab 18 disposed at the edge of lid 16. In order to remove the lid, a user pulls tab 18 of the lid upwards (in the orientation illustrated in the figure). In order to close the opening, the user fixes the lid on the opening by applying force.

It should be noted that the closing mechanism of the lid to the container doesn't use a thread, and therefore the opening and closing is not carried out by rotating the lid with reference to the container.

The novel feature of the dispenser is an impression 20 which comprises different time notations (SUN, MON, etc.), spread on a wall of container 12 along the circumference thereof, in proximity to lid 16. The proximity is better seen in FIG. 2.

As this mechanism does not use a thread, when closing the lid, tab 18 of lid 16 can be placed to point at any of the time notations.

In order to take a pill, a user must open the lid. Since the lid can then be closed such that the tab will point at any notation of impression 20, the tab is used as a pointer to the last day a pill of this container has been dispensed, i.e., the current day. For example, if the user takes a pill on Sunday, he must close the lid such that the tab points to the Sunday notation, as illustrated in FIG. 2.

FIG. 2 schematically illustrates the dispenser of FIG. 1, in its closed state.

In order to take a pill, a user opens lid 16, thereby enabling reaching to the pills stored in container 12. After taking a pill out of the container, the user closes the container in such a way that tab 18 of the lid points at the notation of the current day of impression 20. In FIG. 2 tab 18 points at SUN, which means Sunday.

The next time the user intends to take a pill from the dispenser, the pointer informs him about the last day a pill was taken. Thus, if for example a pill must be taken once in two days, even if the user has forgotten the last time he took a pill, the information provided by the dispenser prevents the user from mistakenly taking more pills than allowed, thereby preventing putting the user in jeopardy.

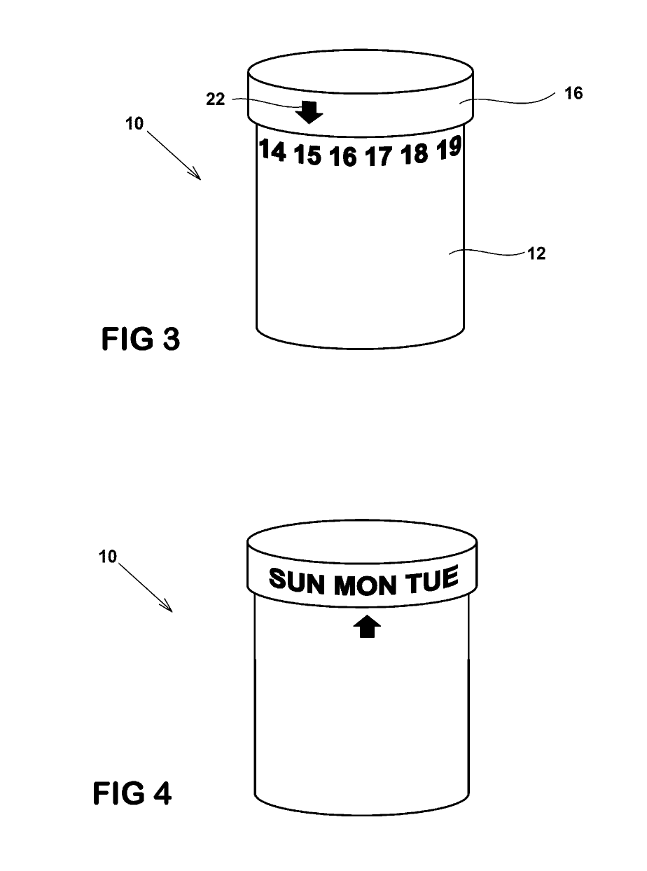

FIG. 3 schematically illustrates a time-oriented pill dispenser, according to another embodiment of the invention.

According to this embodiment of the invention, the time-related notations comprise the days of a month, i.e., 01, 02, . . . , 31. A mark 22 impressed or engraved on the lid replaces the pointing of the tab. In this way, the design of the tab is independent of the notations (e.g., the designer may design its sector size even wider than the sector width of the notation).

FIG. 4 schematically illustrates a time-oriented pill dispenser, according to yet another embodiment of the invention.

According to this embodiment of the invention, the time-related notations are impressed on the lid, while the pointer is impressed on the container, in contrast to the embodiments of FIGS. 1 to 3.

FIG. 5 schematically illustrates a time-oriented pill dispenser, according to yet another embodiment of the invention.

In this embodiment of the invention, impressed notations relates to a single day, in a verbal form, such as MORNING, EVENING, NOON, AFTERNOON, and so on.

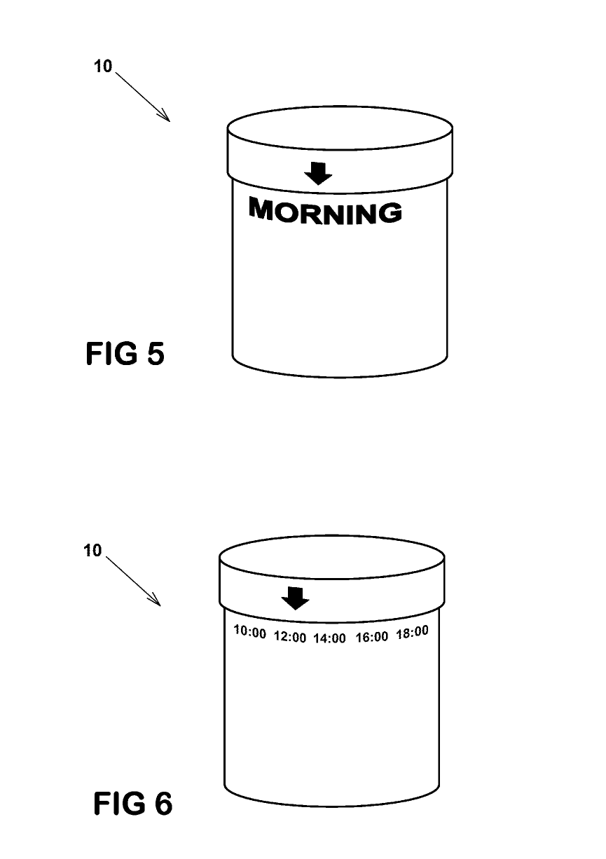

FIG. 6 schematically illustrates a time-oriented pill dispenser, according to yet another embodiment of the invention.

In this embodiment of the invention, the notations are of hours of a single day, such as “10:00, 12:00”, and so on.

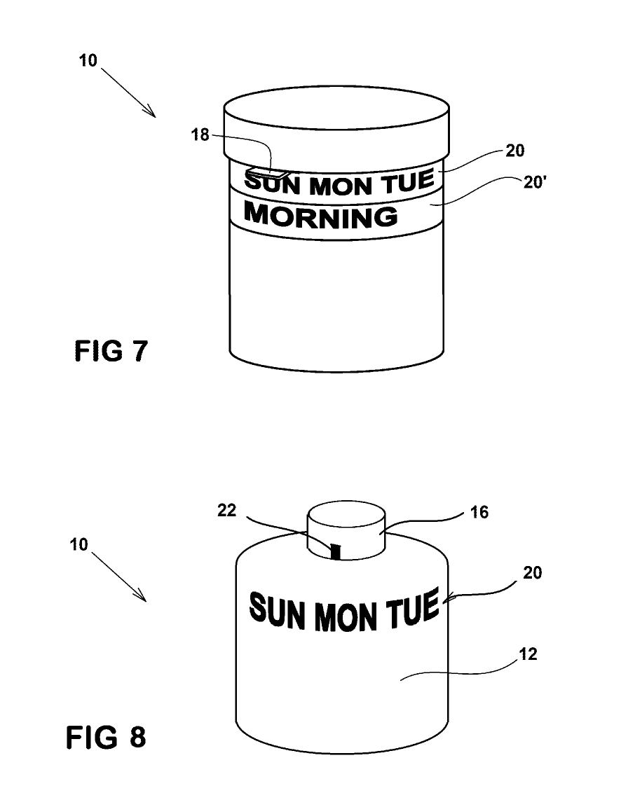

FIG. 7 schematically illustrates a time-oriented pill dispenser, according to yet another embodiment of the invention.

In this embodiment of the invention, the time-related information comprises two impressions, 20 and 20′, each on a different sticker. Impression 20 contains week-related notations (Sun, Mon, etc.), and impression 20′ contains day-related information (Morning, evening, etc.). The user may use one of these stickers, according to his needs.

According to one embodiment of the invention, each of the stickers can be removed, thereby leaving only the relevant information on the container, thereby preventing erring of use.

According to another embodiment of the invention, the user sticks the relevant sticker on the container. Thus, the dispenser is provided with a plurality of stickers, each of a different group of time notations.

FIG. 8 schematically illustrates a time-oriented pill dispenser, according to yet another embodiment of the invention.

In this figure, the upper side (according to the orientation of the figure) of container 12 is rounded. Thus, the form of the container of the bottle may not be prismatic, as in the other figures.

One of the features that must be taken into consideration is preventing accidental displacement of the lid with reference to the container, which may mislead the user about the last time he took a pill.

One solution to this obstacle is using friction between the opening of the container and the lid thereof. Thus, the design must provide some level of tightness, which provides the required friction between the lid and the opening of the container.

According to another embodiment of the invention, the lid is made of elastic material, which provides the required friction between the lid and the opening of the container.

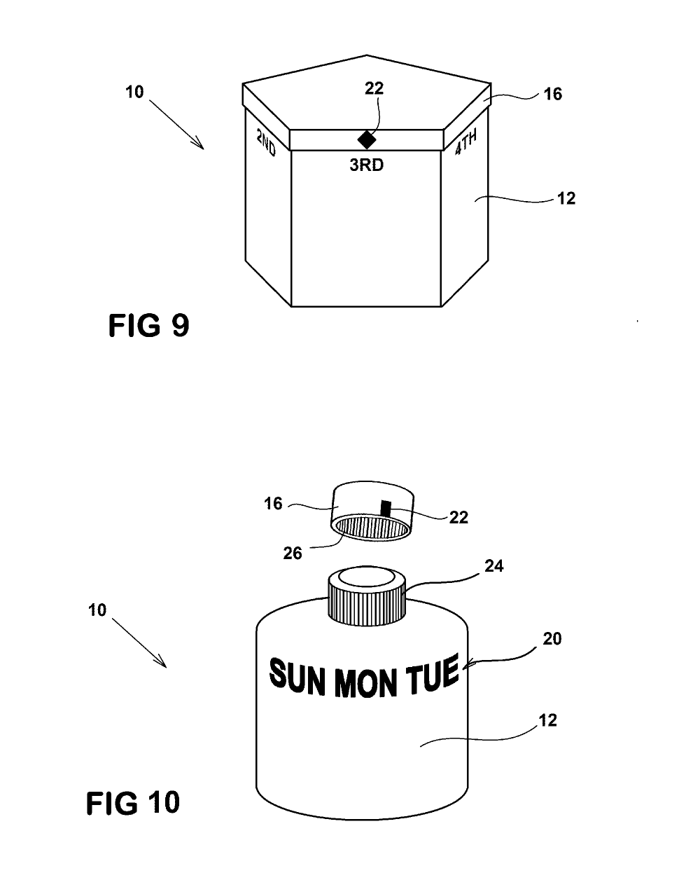

FIG. 9 schematically illustrates a time-oriented pill dispenser, according to yet another embodiment of the invention.

In this exemplary embodiment, the lid and the opening of the bulk pills container is symmetric and pentagonal, thereby preventing unintentional displacement of the lid with reference to the container.

The time-related notations are “1ST, 2ND, 3RD, 4TH, 5TH” (only three are seen in the figure). Thus, according to the design, it is oriented for pills to be taken for 5 days.

Of course, the pentagonal form is only an example, and the form of the opening and corresponding lid may be a polygon of any level.

FIG. 10 schematically illustrates a time-oriented pill dispenser, according to yet another embodiment of the invention.

According to this embodiment of the invention, the external side of the mouth 24 of the opening 14 of the container comprises vertical (according to the orientation of the figure) ribs, and the inner side 26 of lid 16 comprises corresponding vertical ribs. The ribbed surfaces generate the friction required for preventing unintentional displacement of the lid with reference to the container.

It should be noted that the ribs are merely an example, and any non-smooth surface will do, including ledges on one surface and corresponding depressions on the other surface.

The level and form of the meeting surfaces have to provide such friction that on the one hand will allow opening and closing the lid by applying “moderate” force of a user, but on the other hand, will prevent unintentional opening and displacement of the lid with reference to the container.

According to one embodiment of the invention, the pills are identical.

According to another embodiment of the invention, the pills are of different kinds, and the impression is corresponding to the kinds of pills. For example, if a user has to take pill A, which is green, in the morning; and pill B, which is yellow, in the evening, then the impressions may be “MORNING” in green background and “EVENING” in yellow background, intermittently. Thus, the color of the background indicates the color of the pill.

In the figures and/or description herein, the following reference numerals (Reference Signs List) have been mentioned:
numeral 10 denotes a time-oriented pill dispenser, according to one embodiment of the invention;
numeral 12 denotes a bulk pills container of dispenser 10;
numeral 14 denotes an opening of container 12;
numeral 16 denotes a lid of the dispenser;
numeral 18 denotes a tab of lid 16;
each of numerals 20 and 20′ denotes an impression comprising time-related notations;
numeral 22 denotes a mark (used as a pointer) which is not a tab;
numeral 24 denotes the mouth of the opening of the bulk pills container;
numeral 26 denotes the inner side of the surface of the lid of the bulk pills container; and
numeral 28 denotes pills.

Citation List of Patent literature: U.S. Pat. Nos. 3,651,927, 3,450,306, 6,510,962, 5,575,392, 4,534,468, 20030192468, 2,739,564, and EP 0807589.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A time-oriented pill dispenser, comprising:
a bulk pills container (12) having an opening (14) and a corresponding lid (16);
an impression (20) of different time notations, dispersed on an external side of a wall of said container (12) along a circumference thereof, in proximity to said lid (16); and
a pointer in a form of a tab (18) of said lid (16), for pointing at one of said time notations of said impression (20) in a closed state of said container (12);
wherein securing said lid (16) to said container (12) enables placing said pointer to point at each of said notations;
thereby on closing the container (12) by the lid (16), enabling a user marking the current time as the last time of taking a pill from the container by positioning the pointer on the corresponding time notation in the impression.

2. A time-oriented pill dispenser, comprising:
a bulk pills container (12) having a symmetric circular or polygonal opening (14), and a corresponding lid (16);
a plurality of impressions (20, 20′) of different time notations, dispersed on an external side of said lid (16) or said container (12) along a circumference thereof; and
a pointer on said lid (16) or on said container (12), disposed in proximity to said time notations of said impression (20);
wherein securing said lid (16) to said container (12) enables placing said pointer to point at each of said notations;
thereby on closing the container (12) by the lid (16), marking the current time as the last time of taking a pill from the container by positioning the pointer on the corresponding time period in the impression,
wherein said plurality of impressions (20, 20′) being adapted to enable selecting one of said plurality of impressions.

3. A time-oriented pill dispenser, comprising:
a bulk pills container (12) having a symmetric circular or polygonal opening (14), and a corresponding lid (16);
one or more impressions (20, 20′) each of different time notations, dispersed on an external side of said lid (16) or said container (12) along a circumference thereof; and
a pointer on said lid (16) or on said container (12), disposed in proximity to said time notations of said impression (20);
wherein securing said lid (16) to said container (12) enables placing said pointer to point at each of said notations;
thereby on closing the container (12) by the lid (16), marking the current time as the last time of taking a pill from the container by positioning the pointer on the corresponding time period in the impression;
wherein each of said impressions is on a sticker;
thereby (a) reducing a manufacturing effort of said pill dispenser, and (b) enabling using of multiple time impressions from which a user may select one.

4. A dispenser according to claim 1, wherein said time notations are of days of a week.

5. A dispenser according to claim 1, wherein said time notations are of days of a month.

6. A dispenser according to claim 1 wherein said time notations are of hours of a day.

7. A dispenser according to claim 1, wherein said time notations are of descriptive times of a day.

8. A dispenser according to claim 1, wherein an inner side (26) of said lid (16) is ribbed, and an outer side of a mouth (24) of said opening (14) is ribbed, thereby generating a friction which prevents unintentional displacement of said lid with reference to said container.

9. A dispenser according to claim 1, wherein an inner side (26) of said lid (16) is non-smooth and an outer side of a mouth (24) of said opening (14) is non-smooth, thereby generating a friction for preventing unintentional displacement of said lid with reference to said container.

10. A dispenser according to claim 1, wherein said impression (20) is in the form of a print.

11. A dispenser according to claim 1, wherein said impression (20) is in the form of an engraving.

12. A dispenser according to claim 1, wherein a friction and structure between said lid (16) and said opening (14) is designed to prevent unintentional change of a position of said lid with reference to said container.

13. A dispenser according to claim 3, wherein said sticker is removable, thereby allowing a user to remove undesired impression(s) from said container for preventing erring of use.

14. A dispenser according to claim 3, wherein said sticker is attachable, thereby allowing a user to attach a desired impression to said container for preventing erring of use.

15. A dispenser according to claim 1, wherein said pills are of the same kind.

16. A dispenser according to claim 1, wherein said pills are of different kinds, each kind in a different color, corresponding to the background color of the respective time notation.

17. A dispenser according to claim 1, wherein said lid is elastic, thereby providing a friction between the lid and the opening of the container, for preventing unintentional displacement of the lid with reference to the container.

18. A dispenser according to claim 1, wherein said time notations are textual.

19. A dispenser according to claim 1, wherein said time notations are colored.

20. A dispenser according to claim 1, wherein said time notations are in the form of a background color of text.

21. A dispenser according to claim 1, wherein said connection is carried out without a thread.
